(19) United States
(12) Patent Application Publication
(10) Pub. No.: US 2012/0085877 A1
(43) Pub. Date: Apr. 12, 2012

(54) LOOP PIN

(75) Inventors: Hideyuki Ueno, Yokohama-shi (JP); Hitoshi Fujiwara, Shiojiri-shi (JP)

(73) Assignee: M.I.T. INTERNATIONAL CO., LTD., Yokohama-shi, Kanagawa (JP)

(21) Appl. No.: 13/375,330

(22) PCT Filed: Jun. 4, 2010
(86) PCT No.: PCT/JP2010/059896

§ 371 Date: Nov. 30, 2011

(30) Foreign Application Priority Data
Jun. 4, 2009 (JP) 2009-134600

(51) Int. Cl. F16M 13/02

(52) U.S. Cl. 248/224.8

(57) ABSTRACT

The present invention can provide a loop pin which is made of Polypropylene resin with low production costs as well as with highly production efficiency and which is friendly to environment.

The loop pin of the present invention comprises an insertion head portion 5 provided with a first rod section 52, the diameter of the rod there of being smaller than the maximum diameter of the head section 51 of the insertion head portion 5 and a second rod section 53, the diameter of the rod there of being smaller than that of the rod in the first rod section 52, and a socket portion 6 provided with a hole portion 13 and on an inside wall of which a step like portion 15 being formed which comprising a first inclined edge section 18 and a second inclined edge section 20, each being continuously extended from the inner surface wall of the hole portion with a predetermined angle, respectively.

### FIELD OF THE INVENTION

The present invention relates to a loop pin that attaches a tag such as a brand label, a price tag, material description tag, or an instruction tag to product such as clothing, shoes or a bag, or binds a plurality of such good into one pack, and further more, it relates to a loop pin which is capable of increasing strength thereof when the loop pin is attached to a certain good to with such tag.

### BACKGROUND OF THE INVENTION

Generally speaking, such a loop pin 1 has a fiber portion 7 that passes through the tag to form a loop, an insertion head portion 5 being provided on one end of the fiber portion 7, and a socket portion 6 being provided on another end thereof and having a hole 13 through which the head portion 5 passes.

And as shown in FIGS. 10 and 11, when a suitable loop-pins shooting apparatus (a gun) is used, a plurality of loop pins are temporarily attached in parallel to each other to two parallely arranged connection bars 2, 3 so as to form a loop-pin assembly, enabling their easy removal therefrom.

A loop pin 1 is integrally formed of, for example, a synthetic resin material, and has an extremely high resistance to tensile stress. When the insertion head portion 5 is passed through the narrow part(blade part) Of the socket portion 6, the blades 16,16′ provided in the region of the insertion hole 13 are opened, so that a tip end portion 5a of the head portion 5 is held within the socket portion 6 so that as shown in FIG. 12, it cannot be reversed out therefrom, thereby completing the attachment of the looped label.

However, in the past, when such a loop pin assembly in which a plurality of loop pins are removably and temporally connected to the connecting bars 2 and 3, is used, it has been required from a production cost point of view, that a pitch formed among those loop pins should be set at fine distance as possible.

Nevertheless, when such pitch would be shortened, a separate problem would be arisen in that a certain amount of strength of a connecting portion of the loop pin has not been necessarily obtained.

On the other hand, FIG. 12 is a partial cross-section view of the mated condition between an insertion head portion 5 and a socket portion 6 of a loop pin according to the prior art.

In the past, a small-diameter part 5b that connecting a tip end portion 5a of the insertion head portion 5 to the base end portion 5c thereof, was generally formed by two steps.

And further, in an area surrounding the insertion hole 6b of the socket portion 6, a pair of locking blades 6a were provided oppositely facing to each other along the left to right direction as shown in FIG. 12.

Additionally, the locking blades 6a protrude from a base part 6c having a thickness being substantially identical to a half size of a radius of the fiber portion 7.

### PRIOR ART DOCUMENT

### Patent Document

Patent Document No. 1: JPA 2001-199419

### PROBLEM TO BE SOLVED BY THE INVENTION

With regarding to the above-noted loop pin according to the prior art, however, from the problems of the production costs as well as of the characteristics of the product, there has been a new movement in that the material of the loop pin 1 had been changed from Nylon to Polypropylene, in these years.

However, generally speaking, strength of polypropylene resin is relatively lower than that of Nylon and accordingly, it would be necessary to set each of dimensions of such loop pin 1 at a size being relatively larger than those of the loop pin made of Nylon.

Accordingly, in a case when an insertion head portion 5 is inserted into a socket portion 6, if the same level of the break strength of a connected portion of a loop pin as realized by the loop pin made of Nylon, should be obtained by a loop pin made by polypropylene resin, especially, a width of the socket portion 6 thereof is necessarily increased and thus a pitch of the loop pins 1 formed therebetween when they are arranged in parallel with each other as a loop assembly, would probably exceed over 3.5 mm.

Thus in a case when a unit length L of the loop assembly is restricted, there exists a further problem in that a number of the loop pins arranged in the unit length L of the loop pin assembly have to be reduced causing an efficiency of shooting such loop pins into goods to be greatly reduced.

Further, as shown in FIG. 12, when the insertion head portion 5 is inserted into the hole 6a of the socket portion 6, because of the rocking movement of the insertion head portion 5 along the line of the direction as shown by the arrow E, an uneven force is applied to the pair of the locking blades 6a, which lead to the possible damage of the locking blades.

Additionally, because the locking blades of the prior art were so weak and thus the tip ends thereof being able to be easily deformed up and down or left to right, with even a small change in the insertion head portion, the mated part of the insertion head portion could become unattached.

Additionally, when a plurality of prior art loop pins were temporarily attached in parallel to two connection bars, it was not possible to achieve for the plurality of loop pins to be arranged in parallel to each other with small pitch interposed therebetween, because of the limitation imposed by the diameter of the insertion head portion.

For the sake of the above-mentioned, in order to resolve this problems, one prior art referenced as shown in, for example, Japanese Unexamined Patent Publication (KOKAI)No. 2001-199419, discloses a new technical conception in that each one of the construction designs of the insertion head portion 5 and the socket portion 6 should be set at the respective configurations in order to give the substantially same characteristics as of the loop pin as made of Nylon resin to the loop pin as made of Polypropylene as well as to make it possible to arrange the loop pins with extremely high concentration in the loop pin sheet assembly, even when it has been made of Polypropylene.

However, even in this prior art, there still exist several further technical problems in which a configuration of a mold would be more complicated so that this causes to make the production cost to be increased as well as to make the production efficiency thereof to be worsened.

Further, this technical conception gives separate problem in which the blades portion as provided inside of the socket portion 6 cannot be sufficiently reinforced.

Therefore, the object of the present invention is to provide an integrally molded loop pin made mainly of Polypropylene and which can make a configuration of a mold simplified so as to greatly reduce a cost for producing such mold as well as can contribute to increase the production efficiency of the mold.

And the present invention has further objects in that the production cost and the production efficiency of the loop pin can be greatly reduced by making the size thereof to be fine thereby making the arrangement of each one of the loop pins in the loop pin sheet assembly to be highly concentrated, and at the same time the loop pins which is eco-friendly to the environment can be produced by reducing the material to be used and thereby reducing the exhaustion of CO₂.

### MEANS FOR SOLVING THE PROBLEM

In order to attain the above-mentioned object of the present invention, the present invention basically adopts the technical conception as described hereunder.

Note that the first aspect of the present invention relates to a loop pin which comprising a fiber portion, an insertion head portion provided on one end portion of the fiber portion and having an appropriate mating part, and a socket portion provided on another end of the fiber portion and having a hole portion for irreversibly passing the insertion head portion therethrough, the fiber portion, the insertion head portion and the socket portion being integrally formed into one body, wherein, the insertion head portion comprising a head section having a configuration being similar to a conical type shape or a spindle type (corn like type) shape, and a diameter of which being gradually increased in a direction facing to a connecting section formed between the insertion head portion and the fiber portion, a first rod section having substantially a cylindrical configuration, one end portion of which being connected to an end portion of the head section having a maximum diameter in the head section, wherein a diameter of the cylindrical rod section thereof being smaller than the maximum diameter of the head section, and a second rod section having substantially a cylindrical configuration, which being connected to another end portion of the first rod section, wherein a diameter of the cylindrical rod section thereof being smaller than that of the first rod section, further wherein, the hole portion of the socket portion having a center axis being perpendicular to a center axis of the fiber portion as well as having an annular step section being formed on an inner side surface of the hole portion in a direction being perpendicular to the center axis of the hole portion, and further wherein, the step section comprising a first inclined edge portion which continually extending inwardly from a position located in the vicinity of the insertion head portion inserting section provided in the hole portion with a predetermined angle, and a second inclined edge portion which continually extending to the inner side surface of the hole portion from a tip end portion of the first inclined edge portion in a direction facing to the insertion head portion inserting section with a predetermined angle, and further wherein, a diameter of the most inner side portion of the annular step portion being set at a value being smaller than that of the maximum diameter of the head section.

### EFFECT OF THE INVENTION

Since the loop pin of the present invention is adopting the above-mentioned technical conception, the loop pin of the present invention can substantially have the similar characteristics similar to those of the loop pin made of Nylon resin, even if the loop pin of the present invention had made of polypropylene resin.

Further in the present invention, the production cost for producing the same can be reduced and the production efficiency thereof can be increased by simplifying the configuration of the mold thereby greatly reducing the production cost for the mold whereby the production efficiency of the mold as well as by making each one of the sizes of the respective portions of the loop pin to be fine so as to make it possible for a plurality of loop pins to be arranged in a loop-pin assembly sheet with extremely high concentration.

In addition to thereabove, in the present invention, even though, an amount of the material for producing the loop pin of the present invention can be reduced by 10% to 20% of those as used in the past and a diameter of the fiber portion has been reduced as well as over all of the sizes of the insertion head portion and the socket portion have been minimized, the loop pin of the present invention can show strength substantially being identical to that of the loop pin as used in the past.

Note that, in the present invention, by re-considering the parts being equivalent to the over-specifications of the conventional loop pins and by seeking weight saving, resource saving and further cost saving for the loop pin, a sophisticated loop pin which can restrain the generation of industrial wastes and at the same time which can contribute to restrain the exhaustion of CO₂, can be provided.

### BRIEF EXPLANATIONS OF DRAWINGS

FIG. 1 shows a front side plan view illustrating a configuration of one specific example of the loop pin of the present invention.

FIG. 2 shows a partial cross-sectional view illustrating a configuration of one specific example of the loop pin of the present invention.

FIG. 3 shows a back side plan view illustrating a configuration of one specific example of the loop pin of the present invention.

FIG. 4 shows a cross-sectional view illustrating a configuration of one specific example of the step portion of the present invention.

FIG. 5 shows a partial cross-sectional view illustrating a method for measuring the connecting strength of the connected portion in one specific example of the loop pin of the present invention.

FIG. 6 shows a cross-sectional view illustrating a configuration of another specific example of the step portion of the present invention.

FIGS. 7(A) and 7(B) show a cross-sectional view and a plan view, respectively, each illustrating a pin rotation preventing function of a separate example of the loop pin of the present invention.

FIG. 8 shows a side view illustrating a detailed configuration of one example of the loop pin of the present invention.

FIG. 9 shows a view illustrating a detailed configuration of one example of the loop pin of the present invention.

FIG. 10 shows a view illustrating a configuration of the conventional loop pin.

FIG. 11 shows a view illustrating a configuration of a socket portion of one example of a conventional loop pin.

FIG. 12 is a cross-sectional view showing the mating condition formed between the insertion head portion and the socket portion of the conventional loop pin.

### MODE OF CARRYING OUT THE INVENTION

A configuration of one specific embodiment of a loop pin of the present invention will be explained in detail with reference to the drawings, hereunder.

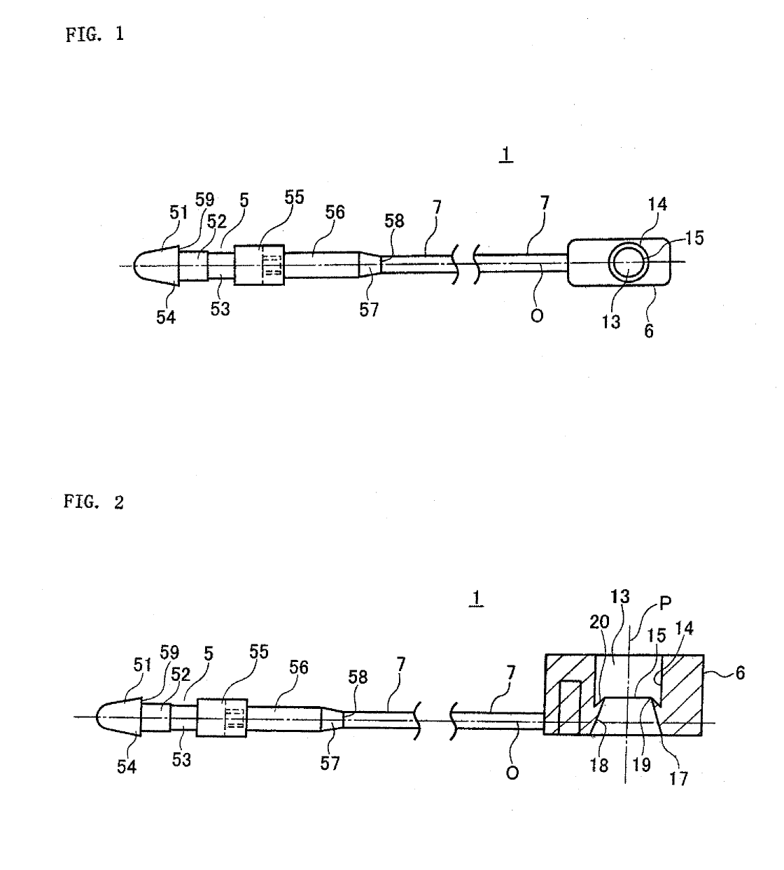

Note that, FIG. 1 is a plan view showing a specific configuration of a loop pin 1 of the present invention and in FIG. 1, it is shown that a loop pin 1, which comprising a fiber portion 7, an insertion head portion 5 provided on one end portion of the fiber portion 7 and having an appropriate mating part 54, and a socket portion 6 provided on another end of the fiber portion 7 and having a hole portion 13 for irreversibly passing the insertion head portion 5 therethrough, the fiber portion 7, the insertion head portion 5 and the socket portion 6 being integrally formed into one body, wherein, the insertion head portion 5 comprising ahead section 51 having a configuration being similar to a conical type shape or a spindle type (corn like type) shape, and a diameter of which being gradually increased in a direction facing to a connecting section 58 formed between the insertion head portion 5 and the fiber portion 7, a first rod section 52 having substantially a cylindrical configuration, one end portion of which being connected to an end portion 59 of the head section 51 having a maximum diameter in the head section 51, wherein a diameter of the cylindrical rod section 52 thereof being smaller than the maximum diameter of the head section 51, and a second rod section 53 having substantially a cylindrical configuration, which being connected to another end portion of the first rod section 52, wherein a diameter of the cylindrical rod section 53 thereof being smaller than that of the first rod section 52, further wherein, the hole portion 13 of the socket portion 6 having a center axis P being perpendicular to a center axis O of the fiber portion 7 as well as having an annular step section 15 being formed on an inner side surface 14 of the hole portion 13 in a direction being perpendicular to the center axis P of the hole portion 13, and further wherein, the step like section 15 comprising a first inclined edge portion 18 which continually extending inwardly from a position located in the vicinity of the insertion head portion inserting section 17 provided in the hole portion 13 with a predetermined angle, and a second inclined edge portion 20 which continually extending to the inner side surface 14 of the hole portion 13 from a tip end portion 19 of the first inclined edge portion 18 in a direction facing to the insertion head portion inserting section 17 with a predetermined angle, and further wherein, a diameter of the most inner side portion of the annular step portion 15 being set at a value being smaller than that of the maximum diameter of the head section 51 which serving as the mating portion 54.

Note that, in a conventional loop pin 1, the insertion head portion 5 has been provided with a pair of wing like blades which can engage with a step like portion provided on an inside surface of a socket portion 6 or provided with a step like portion which can engage with a pair of wing like blades which are provided on an inside surface of a socket portion 6.

However, contrary to this, in the loop pin 1 of the present invention, the insertion head portion 5 comprises a head section 51 having a configuration being similar to a conical type shape or a spindle type (corn like type) shape, a first rod section 52 having substantially a cylindrical configuration having a diameter being smaller than the maximum diameter of the head section 51 and a second rod section 53 having substantially a cylindrical configuration having a diameter being smaller than that of the first rod section 52, and further, inside of the hole portion 13 of the socket portion 6, there is provided with an annular step like section 15 which comprises the first inclined edge portion 18 and the second inclined edge portion 20 and which can engage with the mating part 54 provided on an end portion of the head section 51 having the conical type shape or the spindle type (corn like type) shape.

Further since the present invention has adopted the above-mentioned technical configuration, an insertion operation for inserting the insertion head portion 5 into the hole portion 13 formed inside the socket portion 6 can be carried out very easily as well as the mating operation can also be carried out smoothly by achieving a mutual sliding operation between the head section 51 of the insertion head portion 5 and the first and second inclined edge portions 18 and 29 forming the step like portion 15 inside of the hole portion 13 accompanied by mutual suitable deformations.

Note that, in the present invention, if necessary, it is possible for a slit portion, a groove portion or concaved portion 62 to be provided on the head section 51 of the insertion head portion 5.

Further, FIG. 5 show a view illustrating a measuring method for measuring break strength of a connecting portion 63 in which the insertion head portion 5 and the socket portion 6 of the loop pin 1 are fixedly mated with each other.

Under this method, the respective fiber portions 7 each being extended mutually and oppositely from the connecting portion 63 is captured with a suitable gripping member 64, 64, and then both of the gripping members 64 and 64 are moved with a predetermined speed (for example 144 mm/minute) in mutually opposite direction so as to apart the gripping members 64, 64 form each other, thereby to apply a predetermined tension to the fiber portion 7.

Then, the applied tension at which the connecting portion 63 has been broken or at which the insertion head portion 5 has been drawn out from the connecting portion 63, is detected and it is reduced as the break strength of the connecting portion 63.

In the measuring method as shown in FIG. 5(A), one of the gripping member 64, for example, a hook portion is directly engaged with a part of the connecting portion 63 and simultaneously with this, another gripping member 64, for example, a hook portion is engaged with a middle portion of the looped fiber portion 7 which is opposite to the connecting portion 63 and then by moving both of the gripping members 64, oppositely, the tension as applied to the fiber portion 7 has been measured with a tension meter provided in the vicinity of the connecting portion 63.

On the other hand, in the measuring method as shown in FIG. 5(B), each one of two gripping members, such as hook portions 64, 64, has been engaged with the respective portion on the looped fiber portion 7 which is extended from the connecting portion 63 and the break strength of the connecting portion 63 is measured with the same method as shown in FIG. 5(A).

The results of the measuring thereof are shown in the Table 1 and in which (A) represents the measured data as measured with the measuring method as shown in FIG. 5(A), while, (B) represents the measured data as measured with the measuring method as shown in FIG. 5(B).

TABLE 1

| | (A) | (B) |
|---|---|---|
| MEASURED | 3.19 Kg | 3.76 Kg |
| DATA | 3.78* | 3.72 |
| | 3.74* | 3.62* |
| | 3.43 | 3.67* |
| | 3.44 | 3.74* |
| | 3.39 | 3.84 |
| | 3.18 | 3.69* |
| | 3.29 | 3.66* |
| | 3.73 | 3.87 |
| | 3.08 | 3.71* |
| | 3.28 | 3.85* |
| | 3.62 | 3.66* |
| | 3.59 | 3.16 |
| | 3.92 | 3.75 |
| | 3.55 | 3.55* |
| | 3.22 | 3.69* |
| | 3.00 | 3.55* |
| | 3.34 | 3.80* |
| | | 3.59* |
| | | 3.61 |
| TOTAL | 60.77 | 72.49 |
| MAX | 3.78 | 3.85 |
| MIN | 2.92 | 2.87 |
| R | 0.86 | 0.98 |
| MEAN | 3.376 | 3.625 |

Note that in this Table 1, the data with the mark * means that the data represents a tensile strength measured when an undrawn portion of the fiber portion 7 has been fully drawn and extended.

As apparent from the above-mentioned measured data, it is understood that the connecting portion 63 of the loop pin of the present invention can have the break strength exceeding over 3 Kg, even though it is made of Polypropylene resin as well as the amount of material to be used to produce the loop pin is reduced and the size thereof being minimized in comparing with those of the conventional loop pin.

This level of the break strength of the loop pin of the present invention as made of Polypropylene apparently corresponds to that of the conventional loop pin made of Nylon resin and with the same specification and the same size as the loop pin of present invention has.

After the investigation of the reason why the loop pin 1 of the present invention can show the above-mentioned sophisticated effects or advantages, it has been cleared that in the present invention, as shown in FIG. 5, once after the head section 51 of the insertion head portion 5 and the step like portion 15 of the socket portion 6 has been mated with each other, when the breaking strength of the connecting portion formed by the socket portion 6 and the insertion head portion 5 is measured by extending and drawing the fiber portion 7 in both of left and right directions simultaneously with applying a predetermined tension thereto with interposing the socket portion 6 in the middle of the fiber portion 7, at a position in which a portion of the mating part 54 provided at the most lowest end portion of the head section 51 and a part of the tip end portion 19 provided on the most extended end portion of the step like portion 15, the head section 51 can serve a function as a center portion of a lever so that the head section 51 can pivot around the tip end portion 19 of the step like portion 15, and at the same time, a surface of the most lowest end portion 59 of the head section 51 which is provided at a place substantially opposite to the position at which the mating part 54 provided at the most lowest end portion 59 of the head section 51 is contacted with the tip end portion 19 of the step like portion 15, can be deformed so as to tightly contacted with the second inclined edge portion of the step like portion 15 thereby the head section 51 is more strongly prevented from being dropped out of the step like portion 15.

Further, in the present invention, when the connecting strength of the connecting portion of the insertion head portion 5 and the socket portion 6 is measured, and when the fiber portion 7 is stretched in the right and left directions by applying a predetermined tension thereto with interposing the connecting portion 6 in a middle section of the fiber portion 7, especially the second rod section 53 of the insertion head portion 5 is possibly bended or deformed into curved configuration easily.

Accordingly, since the predetermined tension as applied to the fiber portion 7 is prevented from being directly applied to the mating portion formed between the insertion head portion 5 and the step like portion 15 in the hole portion 13, this fact can contribute to strengthen the strength of the mating portion formed between the insertion head portion 5 and the socket portion 6, in an appearance.

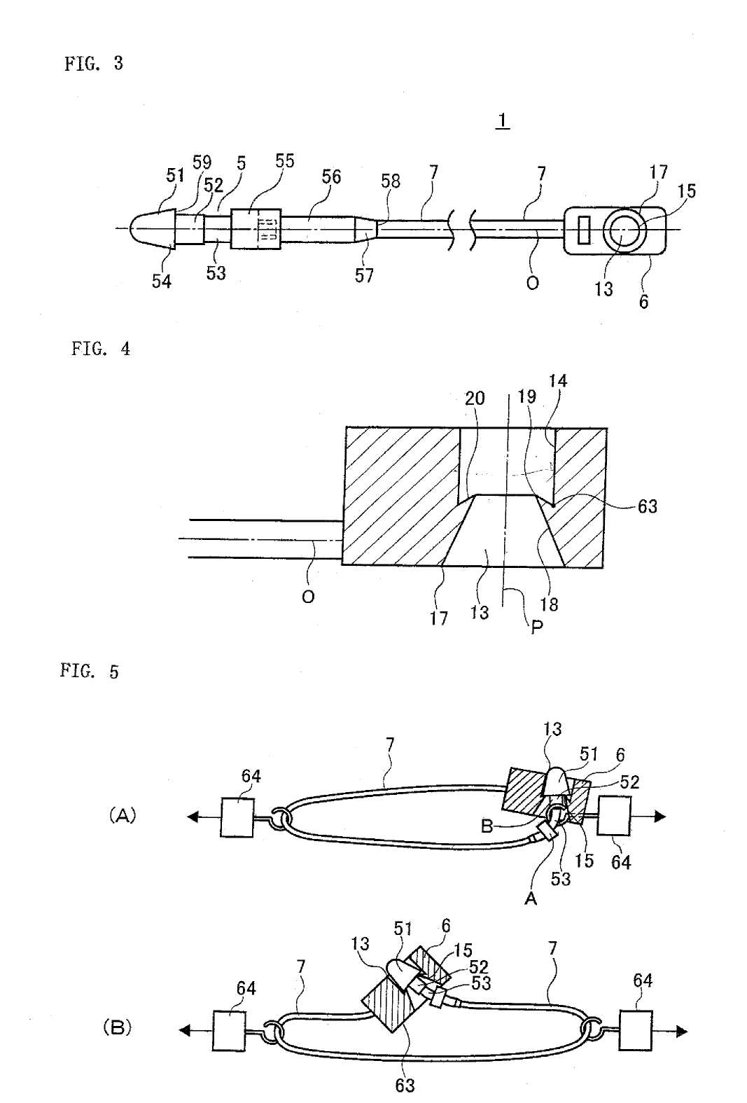

Note that, FIG. 2 is a side view with partially including a sectional view of the loop pin of the present invention as shown in FIG. 1, and FIG. 3 is a back side view thereof.

On the other hand, FIG. 4 is an enlarged cross-sectional side view of the step like portion 15 which is formed inside of the hole portion 13 of the socket portion 6.

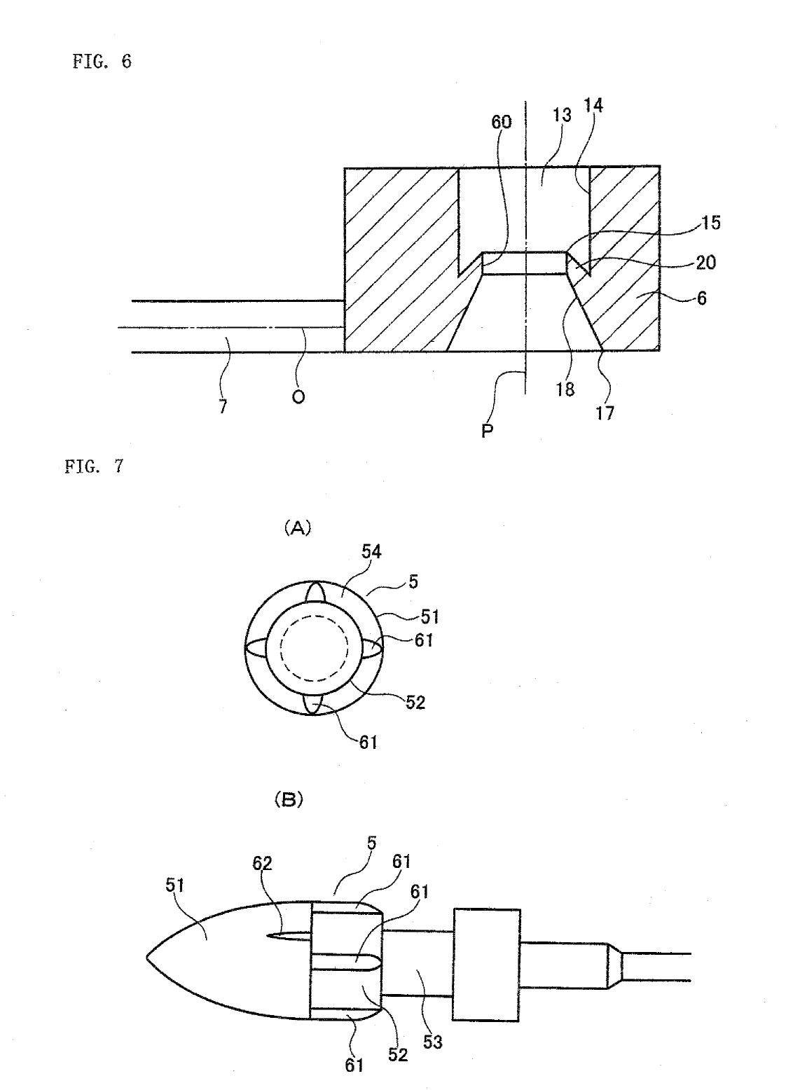

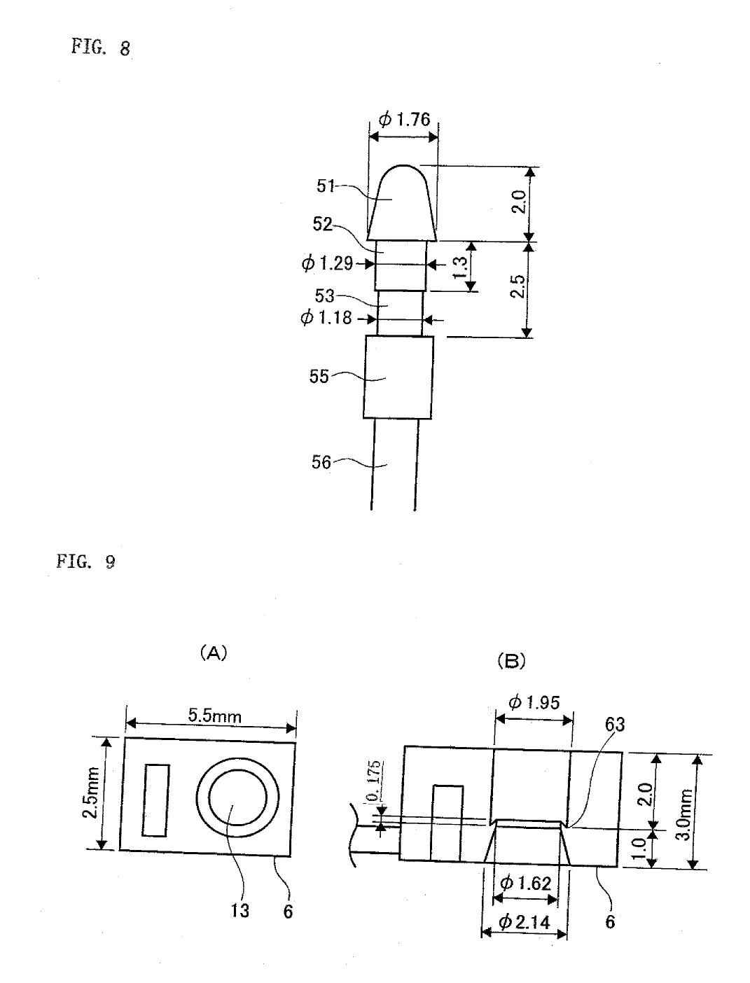

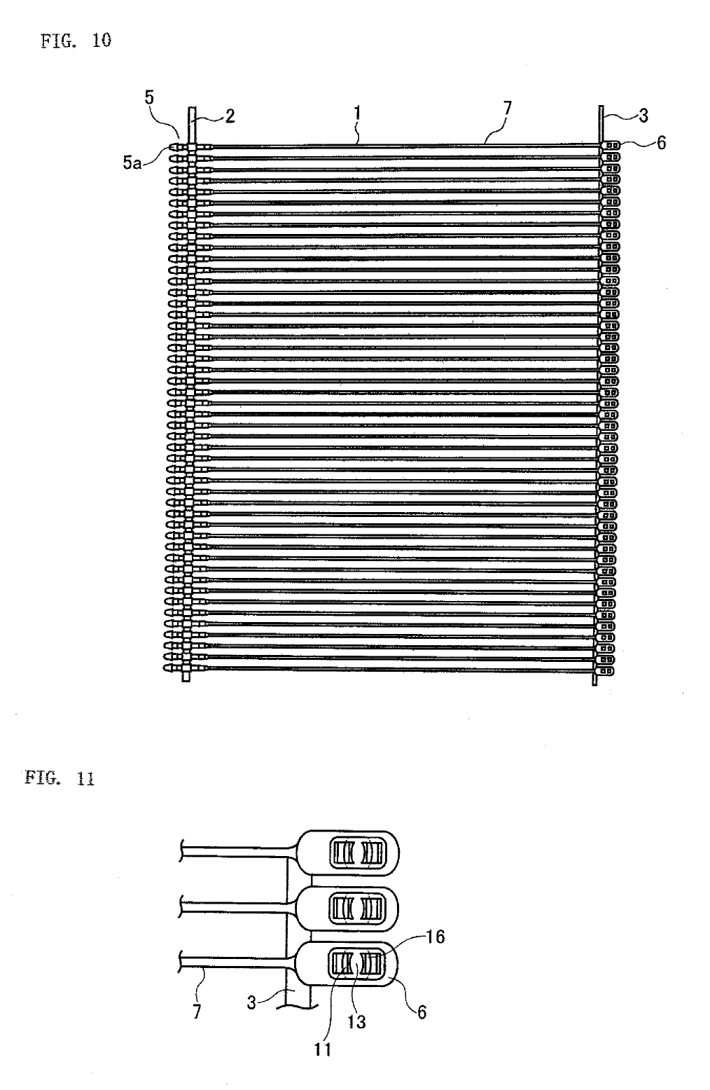

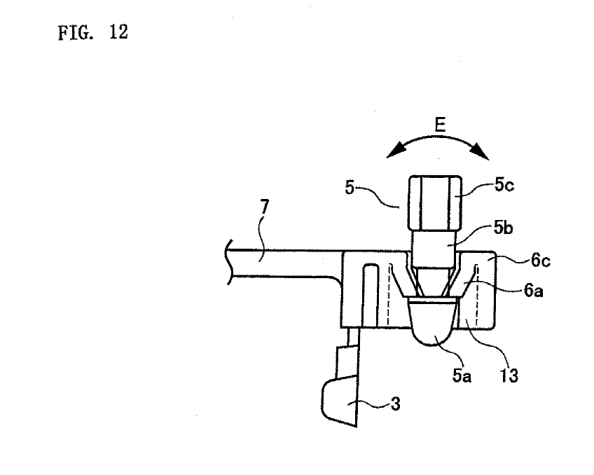

As another specific embodiment of the present invention, for example, as shown in FIG. 6, it is preferable that an annular flat surface 60 which is formed in parallelism with the center axis P of the hole portion 13, is provided at a position 19 at which the first and second inclined edged portions 18 and 20 are intercrossed with each other.

In the present invention, since the above-mentioned technical configurations have been adopted, most lowest end portion 54 of the head section 51 at which the surface of the most lowest end portion 54 of the head section 51 is contacted with the tip end portion 19 of the step like portion 15, the strength of the tip end portion 19 of the step like portion 15 can be increased as well as the effect for preventing the head section 15 which is engaged with the step like portion 15 from being dropped out of the socket portion 6, can also be increased.

On the other hand, as a separate embodiment of the present invention, in the loop pin 1 of the present invention, the fiber portion 7, the insertion head portion 5 and the socket portion 6 are made of polypropylene resin and they are integrally formed into one body.

As a further separate embodiment of the present invention, as shown in FIG. 7, for example, one or a plurality of linear projected portions 61 can be provided on at least a part of the external outer surface of the cylindrical portion of the first rod section 52, and further, by setting a height of each one of the linear projected portions 61 at a value with which the top end portion of the linear projected portion 61 can always contact with the inner wall surface 14 of the hole portion 13 of the socket portion 6, the insertion head portion 5 and the surface of the inner wall of the hole portion 13 of the socket portion 6 are fixedly contacted with each other thereby the effects of the insertion head portion 5 being prevented from being pivotally moved and dropped out of the socket portion 6, can be realized.

### EXAMPLE

A specific example of the loop pin 1 of the present invention will be explained hereunder.

Note that, a loop pin 1 having a configuration as shown in FIGS. 1 to 4, has been produced with integrally molding method and utilizing Polypropylene resin sold in the market as the material.

In this example, the length of the head section 51 of the insertion head portion 5 is set at 2 mm, and the length of the maximum diameter of the lower edge portion 59, corresponding to the mating part 54 of the insertion head portion 5 is set at 1.76 mm (preferably at 1.75 mm to 1.85 mm), and further, the length of the first rod section 52 is set at 1.3 mm (preferably at 1.20 mm to 1.35 mm) and further more, the length of the diameter of the cylindrical rod section 52 is set at 1.29 mm (preferably at 1.20 mm to 1.35 mm).

On the other hand, the length of the second rod section 53 is set at 1.0 mm (preferably at 0.80 mm to 1.30 mm) and the length of the diameter of the cylindrical rod section 53 is set at 1.18 mm (preferably at 0.70 mm to 1.18 mm).

In these Figs., 55 represents an enlarged rod portion having an enlarged diameter and which is connected to another end portion of the second rod section 53 and while, 56 represents an undrawn portion which is connected to both of the enlarged rod portion 55 and the fiber portion 7.

The undrawn portion 56 is connected with the fiber portion 7 at the end portion 58 thereof via a suitable tapered section 57.

Note that, although, the configurations and the length of the enlarged rod portion 55, the undrawn portion 56 and the tapered section 57 are not specifically restricted, each one of the diameter of the respective portions should be set at a value being larger than that of the fiber portion 7.

Further, although the diameter of the cylindrical rod portion of the first rod section 52 is not specifically restricted, it is preferable that the diameter thereof is set at a value being 20% to 35% smaller than the maximum diameter of the head section 51.

As the same reason as mentioned above, the diameter of the cylindrical rod of the second rod section 53 is preferably set at a value being 5% to 25% smaller than that of the first rod section 52.

On the other hand, the thickness T, the length L and the width W of the socket portion 6 can be preferably set at a value of 3.0 mm, 5.5 mm and 2.5 mm, respectively, and further, the inner diameter of the hole portion 13 can be preferably set at 1.95 mm.

And further, the inner diameter of the insertion head portion inserting section 17 provided at the most lowest portion of the hole portion 13 in the socket portion 6, can be set at a value being larger than the inner diameter of the hole portion 13 and thus, for example, it can be set at 2.14 mm.

In this example, it is preferable that the inner diameter of the insertion head portion inserting section 17 as provided in the hole portion 13 can preferably set at a value 5% to 10% larger than that of the hole portion 13.

In this embodiment, in the hole portion 13, there is provided with the first inclined edge portion 18 which is inwardly and upwardly extended inside of the hole portion 13 and from the peripheral edge portion of the insertion head portion inserting section 17 with a predetermined length and with a predetermined angle to the inner wall surface 14 of the hole portion 13.

On the other hand, in the hole portion 13, there is also provided with the second inclined edge portion 20 which is extended from the most inner end portion 19 of the first inclined edge portion 18 inwardly and downwardly in side of the hole portion 13 so as to directing to both of the inner wall surface 14 of the hole portion 13 and the insertion head portion inserting section 17 of the hole portion 13.

Accordingly, inside of the hole portion 13, the annular step like portion 15 having a steeply projected tip end portion 19 is formed and which serving as an engaging member for the mating part 54 provided at the lower end portion 59 of the head section 51 to be engaged with the step like portion 15.

In this embodiment, the most largest inner diameter of the annual step like portion 15 can be preferably set at a value being smaller than that of the portion of the head section 51 which having the maximum diameter.

In this embodiment, it is preferable that the inclined angle of the second inclined edge section 20 to the inner wall surface 14 of the hole portion 13 is set at a value being larger than that of the first inclined edge section 18.

Further, it is also preferable that the position 63 at which the second inclined edge section 20 is intercrossed with the inner wall surface 14 of the hole portion 13, is set at a place on the inner wall with 2.00 mm lower than the upper end edge portion of the socket portion 6 and the positional relationship between the position 63 at which the second inclined edge section 20 is intercrossed with the inner wall surface 14 of the hole portion 13 and the position at which the tip end portion 19 of the step like portion 15 is preferably set at the configuration in that the position of the tip end portion 19 of the step like portion 15 locates at a place with 0.175 mm higher than the position 63 at which the second inclined edge section 20 is intercrossed with the inner wall surface 14 of the hole portion 13.

On the other hand, in the above-mentioned example of the present invention, although, the most smallest inner diameter of the step like portion 15 is set at 1.62 mm, while the maximum diameter of the head section 51 of the insertion head portion 5, it is also preferable that the most smallest inner diameter of the step like portion 15 can be set at a value 15% to 30% smaller than that of the hole portion 13.

As the same manner, the most smallest inner diameter 19 of the step like portion of the present invention, is preferably set at a value 5% to 20% smaller than the maximum diameter of the head section 51.

1. A loop pin which comprising a fiber portion, an insertion head portion provided on one end portion of said fiber portion and having an appropriate mating part, and a socket portion provided on another end of said fiber portion and having a hole portion for irreversibly passing said insertion head portion therethrough, said fiber portion, said insertion head portion and said socket portion being integrally formed into one body, wherein, said insertion head portion comprising a head section having a configuration being similar to a conical type shape or a spindle type (corn like type) shape, and a diameter of which being gradually increased in a direction facing to a connecting section formed between said insertion head portion and said fiber portion, a first rod section having substantially a cylindrical configuration, one end portion of which being connected to an end portion of said head section having a maximum diameter in said head section, wherein a diameter of said cylindrical rod section thereof being smaller than said maximum diameter of said head section, and a second rod section having substantially a cylindrical configuration, which being connected to another end portion of said first rod section, wherein a diameter of said cylindrical rod section thereof being smaller than that of said first rod section, further wherein, said hole portion of said socket portion having a center axis being perpendicular to a center axis of said fiber portion as well as having an annular step section being formed on an inner side surface of said hole portion in a direction being perpendicular to said center axis of said hole portion, and further wherein, said step section comprising a first inclined edge portion which continually extending inwardly from a position located in the vicinity of said insertion head portion inserting section provided in said hole portion with a predetermined angle, and a second inclined edge portion which continually extending to said inner side surface of said hole portion from a tip end portion of said first inclined edge portion in a direction facing to said insertion head portion inserting section with a predetermined angle, and further wherein, a diameter of the most inner side portion of said annular step portion being set at a value being smaller than that of said maximum diameter of said head section.

2. A loop pin according to claim 1, wherein an annular flat surface being formed in parallelism with said center axis of said hole portion is provided at a position at which said first and second inclined edged portions are intercrossed with each other.

3. A loop pin according to claim 1 or 2, wherein, said fiber portion, said insertion head portion and said socket portion are made of polypropylene resin and being integrally formed into one body.

4. A loop pin according to either one of claims 1 to 3, wherein, said diameter of said first rod section is set at a value being 20% to 35% smaller than the maximum diameter of said head section.

5. A loop pin according to either one of claims 1 to 4, wherein, said diameter of said second rod section is set at a value being 15% to 25% smaller than the said diameter of said first rod section.

6. A loop pin according to either one of claims 1 to 5, wherein, a diameter of said insertion head portion inserting section of said hole portion provided in said socket portion is set at a value being 5% to 10% larger than an inner diameter of said hole portion.

7. A loop pin according to either one of claims 1 to 6, wherein, the most smallest inner diameter of said step portion is set at a value being 15% to 30% smaller than said inner diameter of said hole portion.

8. A loop pin according to either one of claims 1 to 6, wherein, the most smallest inner diameter of said step portion is set at a value being 5% to 20% smaller than said maximum diameter of said head section.
